(19) United States
(12) Patent Application Publication
(10) Pub. No.: US 2025/0364859 A1
(43) Pub. Date: Nov. 27, 2025

(54) SET WITH TWO STATOR UNITS, STATOR UNIT FOR A SET, AND METHOD FOR MANUFACTURING THE STATOR UNITS

(71) Applicant: ZF Friedrichshafen AG, Friedrichshafen (DE)

(72) Inventors: Tobias SCHRENK, Bad Neustadt an der Saale (DE); Julian WINKLER, Elfershausen (DE); Lukáš MERGL, Plzen (CZ)

(21) Appl. No.: 19/216,972

(22) Filed: May 23, 2025

(30) Foreign Application Priority Data
May 24, 2024 (DE) 10 2024 204 823.2

(51) Int. Cl. H02K 3/28

(52) U.S. Cl. CPC H02K 3/28

(57) ABSTRACT

A set having a first stator unit, with a first interconnection device for interconnecting a stator winding to form a delta circuit, the first interconnection device having three connection rails for contacting respective phase strands of the stator winding and an insulation housing with a receiving structure for receiving the connection rails; and a second stator unit having a second interconnection device for interconnecting a stator winding to form a star point circuit, the second interconnection device having three connection rails, each for contacting one phase strand of the stator winding, a star point rail for contacting all phase strands of the stator winding and an insulation housing with a receiving structure for the connection and the star point rails.; The receiving structures of the first and second interconnection devices are of identical construction and/or the insulation housings of the first and second interconnection devices are identical parts.

### BACKGROUND OF THE INVENTION

### 1. Field of the Invention

The disclosure relates to a set having stator units, a stator unit, in particular for a set, and to a method for manufacturing the stator units.

### 2. Description of Related Art

Electric machines are known in which a stator winding of a stator is contacted with a high-voltage connection, e.g. power electronics, by an interconnection arrangement to apply a voltage to the individual phases of the stator winding. The stator winding usually has three phases, which can be connected either in a star connection or a delta connection.

DE 10 2022 210 667 A1, for example, discloses a motor stator for a motor. The motor stator includes a stator body and a multiplicity of windings. The stator body includes a weld end, a crown end and a multiplicity of slots arranged circumferentially and extending axially between the weld end and the crown end. Each winding includes a phase line, a neutral line and a multiplicity of coils. The multiplicity of coils includes a same-layer conductor coil including two legs extending across a plurality of slots of the multiplicity of slots and inserted into respective slots at a same layer thereof. The same-layer conductor coil positions the phase cable at the weld end. The neutral line and the welds that connect the multiplicity of coils are all positioned at the weld end. The motor stator further comprises a bus bar disposed at the weld end, wherein the welds of the phase lead and the neutral line for each of the multiplicity of windings are formed at the weld end such that all the welds of the motor stator are formed at the weld end.

### SUMMARY OF THE INVENTION

An object of the invention is to create a stator unit of the type mentioned at the outset, which is distinguished by simplified and cost-effective assembly.

This object is achieved by a set and by a stator unit, and by a method. Further aspects and advantages according to the invention can be found in the corresponding dependent claims and the following description and attached figures.

The subject of one aspect of the invention is a set comprising a first and a second stator unit. In particular, the first and second stator units are designed and/or suitable for an electric machine. Preferably, the first or second stator unit can be selected from the set to form the electric machine and combined with other components, for example a rotor, housing, etc. In particular, a first electric machine is formed by using the first stator unit and a second electric machine is formed by using the second stator unit.

The first stator unit has a first interconnection device which is designed and/or suitable for interconnecting a stator winding to form a delta connection. For this purpose, the first interconnection device has three connection rails for contacting one phase strand of the stator winding and an insulation housing with a receiving structure for receiving the connection rails. In particular, the stator winding of the first stator unit has exactly three phase strands (U, V, W), wherein the three phase strands are connected via the three connection rails to form a delta connection. The connection rails are particularly preferred for contacting the phase strands with power electronics.

The second stator unit has a second interconnection device which is designed and/or suitable for interconnecting a stator winding to form a star point connection. For this purpose, the second interconnection device has three connection rails for contacting one phase strand of the stator winding, a star point rail for contacting all phase strands of the stator winding and an insulation housing with a receiving structure for receiving the connection rails and the star point rail. In particular, the stator winding of the second stator unit has exactly three phase strands (U, V, W), wherein the three phase strands are connected via the three connection rails and the star point rail to form a star connection. Preferably, the star point rail forms a star point of the star connection. The connection rails are particularly preferred for contacting the phase strands with power electronics.

In the context of one aspect of the invention, it is proposed that the receiving structure of the first and second interconnection device are of identical design. Alternatively or optionally in addition, the insulation housing of the first and second interconnection devices are designed as identical parts. In other words, two different interconnection devices are proposed, which have an identical receiving structure and/or an identical insulation housing. This means that the same insulation housing can be used to form the first and second interconnection device, wherein the change between delta and star connection is realized by adding the optional star point rail. In particular, the receiving structure is used to interlockingly hold the connection rail and the optional star point rail. Preferably, the connection rails and, if applicable, the star point rail are electrically insulated from each other in the respective associated receiving structure. The insulation housing can be made of any electrically insulating material, for example plastic or ceramic. In particular, the receiving structure is designed in such a way that at least the star point rail for forming the first interconnection device can be omitted and added to form the second interconnection device without changing the insulation housing or the receiving structure.

One aspect of the invention is based on the realization that delta and star circuits are produced with stator windings that are always plugged in the same way as well as an adaptation of the wiring device and bending of the winding ends. This requires a large axial free length of the winding ends up to the interconnection device and the use of an additional support component to support the long winding ends in order to ensure fatigue strength over the service life. An advantage of one aspect of the invention is that the manufacturing costs for the production of delta-and star-interconnected stator units can be reduced by using identical receiving structures or insulation housings. Assembly can also be significantly simplified, as only the star point rail needs to be mounted in the provided receiving structure to switch from delta to star connection.

In a specific aspect, it is provided that the receiving structure has a receiving portion for each of the three receiving rails on an upper side of the insulation housing and a further receiving portion for the star point rail on a lower side of the insulation housing, wherein the further receiving portion of the first interconnection device is unoccupied and the further receiving portion of the second interconnection device is occupied by the star point rail. In other words, the star point rail is arranged below the connection rails. Preferably, at least the further receiving portion is open in one mounting direction, in particular in the axial direction in relation to a stator axis, so that the star point rail can be inserted or mounted axially in the further receptacle if required. This makes it particularly easy to retrofit the star point rail to implement the star connection.

In a development, it is provided that the first and second stator units each comprise a stator body and a stator winding, wherein the stator body and/or the stator winding of the first and second stator units are designed as identical parts. The stator winding is preferably arranged on the stator body of the stator, wherein the stator body has several stator slots extending along a stator axis, into which the stator winding is inserted in portions. Preferably, the stator winding is formed by a plurality of plug-in coils. Preferably, each plug-in coil runs through at least one, preferably exactly two stator slots spaced apart in the circumferential direction. The stator winding can be designed as a hairpin winding or a wave winding. For this purpose, the plug-in coils can be designed as hairpins, I-pins or D-pins. The stator winding has the three phase strands, wherein each phase strand can be formed from at least or exactly two partial strings. In particular, each phase strand or each partial string has at least or exactly one winding end. The winding ends preferably extend in an axial direction in relation to a stator axis, preferably parallel and/or in the same direction as the stator axis. In particular, the winding ends protrude in the axial direction from a winding head of the stator winding on at least one axial end face. It is particularly preferred that the winding ends extend along a radial inner diameter of the stator winding in the axial direction. A set is thus proposed in which the stator units can be formed with a large number of identical parts, thus enabling a further reduction in manufacturing costs.

In a specific aspect, it is provided that the three connection rails of the first and second interconnection devices each have a group of connection lugs for connecting at least or exactly one winding end of the respective phase strand and a rail portion for connection to a power electronics unit, wherein the rail portions and at least some of the connection lugs of the first and second interconnection devices form a common sub-portion. In other words, the connection rails of the first and second interconnection devices are designed in portions as identical parts. Preferably, the rail portions are of the same or identical design and the connection lugs are of the same or identical design in some portions. Preferably, each connection rail has several connection lugs via which several winding ends of a phase strand can be contacted. In particular, the change between delta and star connection can be made by adjusting the connection lugs, while the rail portions remain the same. This means that the same connection rails can be produced for both the delta and star connection during the manufacturing process and subsequently modified or adapted, in particular to form the second interconnection device. It is particularly preferred that the first and second stator units can be manufactured exclusively with identical parts. This allows manufacturing costs to be further reduced.

In one aspect, it is provided that the first and second interconnection devices can be arranged and/or are arranged in a fixed angular position relative to the respective associated stator body in an installation situation. In other words, the first and second interconnection devices are arranged in the same position relative to the respective associated stator body. In simplified form, the first and second interconnection devices, preferably at least the respective insulation housing, can be arranged congruently with one another on the respective stator body. This can further simplify assembly, as the first and second interconnection devices can be positioned in the same position relative to the stator body and can therefore be arranged or held in position in the same assembly tool.

According to this disclosure, it is provided that the connection lugs of the three connection rails of the first interconnection device are arranged in a connection region of n stator slots. In particular, the connection region corresponds to an angular range defined by a fixed number of stator slots. For example, the connection region extends in the circumferential direction over more than 10, preferably more than 15, in particular more than 20 stator slots. Alternatively or optionally in addition, the connection region extends in the circumferential direction over less than 25, preferably less than 20, in particular less than 15 stator slots. The connection lugs of the three connection rails of the first interconnection device are particularly preferably arranged within a connection region of exactly n=18 stator slots.

In a development, it is provided that the star point rail of the second interconnection device has a group of connection lugs for connecting at least one winding end per phase strand and a connection portion for connecting the connection lugs. In other words, the star point rail has three groups of connection lugs, which are connected to each other via the connection portion, preferably to form the star point. According to this development, it is provided that the connection lugs of the three connection rails of the second interconnection device and the connection lugs of the star point rail of the second interconnection device are arranged in a connection region of n stator slots. In simplified terms, the first connection region defined by the connection rails of the first interconnection device is equal to the second connection region defined by the connection rails and the star point rail of the second interconnection device. Here, “equal” means that the two connection regions have the same angular range, but can be arranged offset to each other in the circumferential direction. Preferably, the connection lugs of the three connection rails and the connection lugs of the star point rail are each arranged in a connection region of n/2 stator slots. In other words, the connection lugs of the connection rails and the connection lugs of the star point rail each extend halfway into the connection region. Specifically, this means that the connection lugs of the second interconnection device must be shortened by half or by the angular range of n/2 stator slots in order to free up the connection region for the connection lugs of the star point rail. This enables a particularly compact design of the interconnection devices, wherein both a delta and a star connection can be easily realized by disconnecting unneeded connection lugs.

In a further specific implementation, it is provided that the connection region of the first and second interconnection device extends in an angular range of more than 90 degrees and/or less than 180 degrees. In particular, the connection region extends in an angular range of at least or exactly 120 degrees. A first and second interconnection device is therefore proposed, which provides several connection positions over a large angular range in order to contact several sub-strands with the respective interconnection device via the connection lugs.

In a further specification, it is provided that an angular distance between the connection lugs corresponds to an angular distance between the stator slots. In other words, the number of stator slots in the connection region corresponds to the number of connection lugs. For example, the first and second interconnection devices each have a number of n=18 connection lugs, wherein the connection rails of the first interconnection device each provide six connection lugs per phase strand and the connection rails and the star point rail of the second interconnection device each provide three connection lugs per phase strand. In other words, instead of six connection lugs per connection rail, the second interconnection device for each phase strand has only three connection lugs per connection rail, wherein the missing connection lugs are provided by the connection lugs of the star point rail. In this way, a stator winding with a maximum of six winding ends per phase strand can be made into either a delta or a star connection by contacting one winding end with one connection lug each.

In a further aspect, it is provided that all the connection lugs of the first and second connecting units are each located on a pitch circle, wherein the connection lugs of the three connection rails of the first connecting unit are arranged in groups one after the other in the circumferential direction and the connection lugs of the three connection rails of the second connecting unit are arranged in groups alternating with the connection lugs of the star point rail. In particular, all connection lugs, especially in an initial state of the first and/or second interconnection device, are arranged within the respective connection region with the same angular spacing, in particular corresponding to a groove pitch of the stator body. This allows the winding ends to be guided directly out of the plug-in region or the stator slots and contacted directly with the respective connection lug. In addition, wiring directly above the winding head is possible, which means that additional support for the winding ends can be dispensed with, as these can emerge directly from the stator slots or the plug-in region of the stator winding. A stator unit with a reduced overall axial length is therefore proposed.

In a preferred aspect, it is provided that the rail portions of the three connection rails of the first interconnection device are each connected to connection lugs in the center of the respective associated group and/or the connection portion of the star point rail of the second interconnection device is in each case connected to connection lugs in the center of the respective associated group. The vibration properties of the connection lug, including the connected winding ends, can be optimized by connecting the rail portions or the connection portion in the center.

In a further specific realization, it is provided that the connection lugs of the first interconnection device and the winding ends of the stator winding of the first stator unit are arranged offset in the circumferential direction by at least or exactly one stator slot relative to the connection lugs of the second interconnection device and the winding ends of the stator winding of the second stator unit.

Alternatively or optionally in addition, the connection region of the first interconnection device is offset in the circumferential direction by at least or exactly one stator slot relative to the connection region of the second interconnection device. In other words, a first winding end of one stator unit exits at a stator slot n1 and the first winding end of the other stator unit exits at a stator slot n2. In other words, with an arrangement in a connection region of n=18 stator slots, one interconnection device provides a connection lug for each of the stator slots n1 to n18 and the other interconnection device provides a connection lug for each of the stator slots n2 to n19. This creates an offset of exactly one stator slot in the circumferential direction. An offset of exactly two or more stator slots can also be formed in the circumferential direction, as shown in the following tables. The offset in the circumferential direction also enables a central or at least approximately central connection of the rail portions of the connection rails of the second interconnection device if the connection lugs are shortened to form the star connection or to form free areas for the connection lugs of the star point rail.

According to the following table, the following connection configurations Y-Var1, Y-Var2 or Y-Var3 (phases U, V, W; star points S) for a star connection are possible for an exemplary stator body with a total of 54 slots and a number of n=18 stator slots or n=18 connection lugs in the connection region:

| | Angular distance in ° | | | | | | | | | |
|---|---|---|---|---|---|---|---|---|---|---|
| | 0 | 6.67 | 13.33 | 20.00 | 26.67 | 33.33 | 40.00 | 46.67 | 53.33 | 60 |
| Position | 1 | 2 | 3 | 4 | 5 | 6 | 7 | 8 | 9 | 10 |
| Y-Var1 | S | S | S | U | U | U | S | S | S | V |
| Y-Var2 | S | S | | U | U | | S | S | | V |
| Y-Var3 | S | | | U | | | S | | | V |

| | Angular distance in ° | | | | | | | | | |
|---|---|---|---|---|---|---|---|---|---|---|
| | 66.67 | 73.33 | 80.00 | 86.67 | 93.33 | 100.00 | 106.67 | 113.33 | 120.00 | 126.67 |
| Position | 11 | 12 | 13 | 14 | 15 | 16 | 17 | 18 | 19 | 20 |
| Y-Var1 | V | V | S | S | S | W | W | W | | |
| Y-Var2 | V | | S | S | | W | W | | | |
| Y-Var3 | | | S | | | W | | | | |

According to the following table, the following connection configurations Δ-Var1, Δ-Var2 or Δ-Var3 (phases U, V, W) for a delta connection are possible for the exemplary stator body by offsetting the stator winding by exactly two stator slots or two connection positions (position 1, position 2):

| | Angular distance in ° | | | | | | | | | |
|---|---|---|---|---|---|---|---|---|---|---|
| | 0 | 6.67 | 13.33 | 20.00 | 26.67 | 33.33 | 40.00 | 46.67 | 53.33 | 60 |
| Position | 1 | 2 | 3 | 4 | 5 | 6 | 7 | 8 | 9 | 10 |
| Δ-Var1 | | | U | U | U | U | U | U | V | V |
| Δ-Var2 | | | U | U | | U | U | | V | V |
| Δ-Var3 | | | U | | | U | | | V | |

| | Angular distance in ° | | | | | | | | | |
|---|---|---|---|---|---|---|---|---|---|---|
| | 66.67 | 73.33 | 80.00 | 86.67 | 93.33 | 100.00 | 106.67 | 113.33 | 120.00 | 126.67 |
| Position | 11 | 12 | 13 | 14 | 15 | 16 | 17 | 18 | 19 | 20 |
| Δ-Var1 | V | V | V | V | W | W | W | W | W | W |
| Δ-Var2 | | V | V | | W | W | | W | W | |
| Δ-Var3 | | V | | | W | | | W | | |

A further object of the invention relates to a stator unit, in particular for a set as described above. The stator unit has an interconnection device which has an insulation housing with a receiving structure, wherein the receiving structure is designed to optionally receive three connection rails in order to form the interconnection device as a delta circuit or the stator unit as the first stator unit, or to receive three connection rails and a star point rail in order to form the interconnection device as a star circuit or the stator unit as the first stator unit.

A further object of the invention relates to a method for manufacturing a stator unit, in particular a first and a second stator unit, as previously described. For this purpose, a stator body, a stator winding and an interconnection device for interconnecting the stator winding to form a delta circuit or a star circuit are provided, wherein the stator winding has one or more winding ends per phase strand. If a delta connection is to be produced, the stator winding is inserted into the stator body in a predefined first angular position and the interconnection device is arranged in a fixed angular position relative to the stator, wherein at least one winding end of a phase strand is contacted with a respective connection rail of the interconnection device. In other words, at least one winding end of a phase strand is contacted with a connection lug of an associated connection rail. This means that at least one winding end of the stator winding is connected per connection rail to form the delta connection. If a star connection is to be produced, the stator winding is inserted into the stator body in a predefined second angular position, the interconnection device is supplemented by a star point rail and the interconnection device is arranged in one or the same defined angular position relative to the stator, wherein at least one winding end of each phase strand is contacted with a connection rail of the interconnection device and at least one winding end of each phase strand is contacted with the star point rail. In other words, one winding end of each phase strand is contacted with one connection lug of an associated connection rail and one winding end of each phase strand is contacted with one connection lug of the star point rail. To form the star connection, at least one winding end of the stator winding is connected per connection rail and one winding end of each phase strand is connected to the star point rail

In a development, it is provided that the connection rails of the second interconnection device are shortened to form free areas for the star point rail. In particular, the connection rails are shortened symmetrically or at least almost symmetrically to ensure that the rail portions continue to be connected centrally. Alternatively or optionally, the connection rails can also be shortened by the number of unused or excess connection lugs after the winding ends have been connected.

In a further aspect, it is provided that the stator winding is inserted in the first angular position offset by one or more, preferably exactly two, stator slot(s) in the circumferential direction relative to the second angular position. For example, the stator winding is inserted with the first winding end into the stator slot n1 for a delta connection and with the first winding end into the stator slot n2 or n3 for a delta connection. By inserting the stator winding with a slot offset, a central or almost central connection of the connection lugs can be achieved after the connection lugs have been shortened or cut off.

### BRIEF DESCRIPTION OF THE DRAWINGS

The invention will be explained in more detail below with reference to the drawings, in which:

FIG. 1 is an axial plan view of a first interconnection device for delta connection of a first stator unit;

FIG. 2 is a detailed perspective view of the first stator unit connected in a triangle with the first interconnection device;

FIG. 3 is an axial plan view of a second interconnection device for star connection of a second stator unit; and

FIG. 4 is a detailed perspective view of the second star-connected stator unit with the second interconnection device.

### DETAILED DESCRIPTION OF THE PRESENTLY PREFERRED EMBODIMENTS

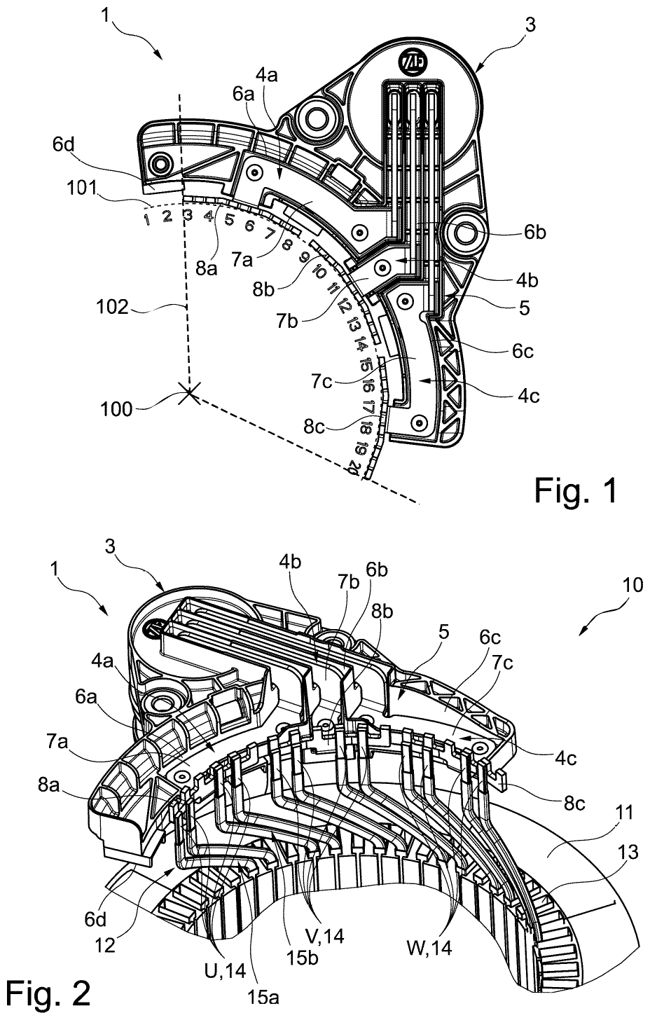

FIG. 1 shows a first interconnection device 1, which is used to interconnect a stator winding 12, as shown in FIG. 2, to form a delta connection. The first interconnection device 1 has an insulation housing 3 and three connection rails 4a, 4b, 4c, in particular also referred to as U, V, W rails, which are interlockingly and electrically insulated from one another in a receiving structure 5 of the insulation housing 3.

The insulation housing 3 is made of a plastic, for example, preferably an injection-molded plastic, wherein the receiving structure 5 is formed by a recess, for example a negative contour of the respective connection rail 4a, 4b, 4c. The receiving structure 5 has a first receiving portion 6a for receiving a first connection rail 4a, a second receiving portion 6b for receiving a second connection rail 4b and a third receiving portion 6c for receiving a third connection rail 4c, wherein the receiving portions 6a, 6b, 6c are spatially separated from one another or electrically insulated by webs, ribs, walls or the like. For example, the receiving portions 6a, 6b, 6c are open in the axial direction with respect to a stator axis 100, so that the individual connection rails 4a, 4b, 4c can be inserted or mounted in the respective receiving portion 6a, 6b, 6c in the axial direction or from above. The connection rails 4a, 4b, 4c can be fixed in the respective receiving portion 6a, 6b, 6c using hot caulking, for example.

The connection rails 4a, 4b, 4c each have a rail portion 7a, 7b, 7c and a group of connection lugs 8a, 8b, 8c, which are each connected to each other in one piece or made from a common material portion. The rail portions 7a, 7b, 7c are used to connect to the power electronics and the connection lugs 8a, 8b, 8c to connect the stator winding 2. The connection lugs 8a, 8b, 8c are arranged on a common pitch circle 101, only partially shown, around a stator axis 100, wherein the connection lugs 8a, 8b, 8c are arranged in groups one after the other in the circumferential direction. The rail portions 7a, 7b, 7c are each connected to connection lugs 8a, 8b, 8c in the center of the respective group in order to optimize the vibration properties of the connection lugs 8a, 8b, 8c in an installation situation.

FIG. 2 shows a first stator unit 10 for a first electric machine, which is used, for example, to generate an electric drive torque, in particular a traction torque for an electric axle of a vehicle. The electric machine is designed as an internal rotor and can have a rotor, not shown, arranged radially inside the first stator unit 10. The stator axis 100 can, for example, be defined by a rotation axis of the rotor.

The first stator unit 10 comprises a stator body 11 and a multi-phase stator winding 12, wherein the stator body 11 carries the stator winding 12. For this purpose, the stator body 11 has several stator slots 13 distributed in the circumferential direction and running in the axial direction with respect to the stator axis 100.

The stator winding 12 is formed, for example, by several plug-in coils, for example in the form of hairpins or I-pins, which are interconnected in a specific pattern. The stator winding 12 is inserted into the stator slots 13, wherein several of the plug-in coils can be arranged per stator slot 13. The stator winding 12 has exactly three phase strands U, V, W, wherein each phase strand U, V, W comprises two partial strings 15a, 15b also referred as strands, which are each formed by a plurality of plug-in coils. The partial strands 15a, 15b each have two winding ends 14, which extend in the axial direction in relation to a stator axis 100 parallel and/or in the same direction to each other on an inner diameter of the stator winding 12.

The phase strands U, V, W are connected via the first interconnection device 1 to form a delta connection, wherein the winding ends 14 of the two partial strings 15a, 15b of the first phase strand U are connected to the connection lugs 8a of the first connection rail 4a, the winding ends 14 of the two partial strings 15a, 15b of the second phase strand V are contacted with the connection lugs 8b of the second connection rail 4b and the winding ends 14 of the two partial strings 15a, 15b of the third phase strand W are contacted with the connection lugs 8c of the third connection rail 4c.

For this purpose, the interconnection device 1 is arranged in a fixed angular position relative to the stator body 11, wherein the connection lugs 8a, 8b, 8c of the three connection rails 4a, 4b, 4c of the first interconnection device 1 are arranged in a fixed first connection region 102 of n=18 stator slots 13. Each connection rail 4a, 4b, 4c has six connection lugs 8a, 8b, 8c, wherein each of the connection lugs 8a, 8b, 8c is assigned to a stator slot 13. An angular distance between the individual connection lugs 8a, 8b, 8c corresponds to an angular distance between the stator slots 13. For example, the stator body 11 has a total of 54 stator slots 13, wherein the connection lugs 8a, 8b, 8c are assigned to the stator slots n3 to n20, as indicated in FIG. 1. With n=18 stator slots 13, the first connection region 102 thus extends over an angular range of 120°.

In the exemplary embodiment shown, the winding ends 14 of the first phase strand U exit at the stator slots n3, n4, n6, n7, the winding ends 14 of the second phase strand V exit at the stator slots n9, n10, n12, n13 and the winding ends 14 of the third phase strand W exit directly at the stator slots n15, n16, n18, n19. In other words, the connection lugs 8a, 8b, 8c assigned to the stator slots n5, n8, n11, n14, n17, n20 are unused.

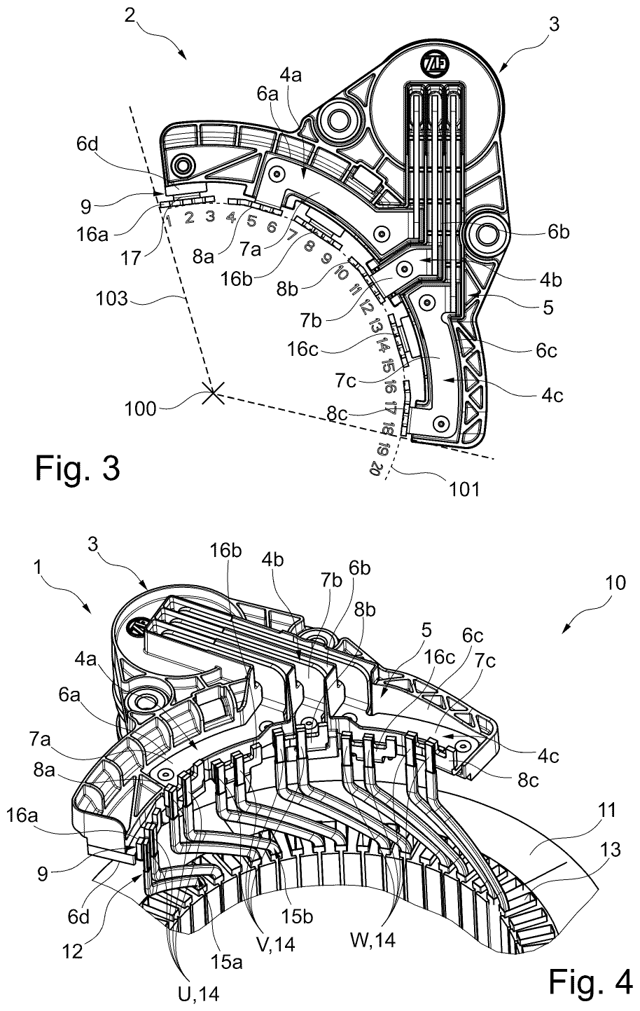

FIG. 3 shows a second interconnection device 2, which is used to interconnect a stator winding 12, as shown in FIG. 4, to form a star connection. The second interconnection device 2 has an insulation housing 3, three connection rails 4a, 4b, 4c, in particular also referred to as U, V, W rails, and a star point rail 9, which are held in a receiving structure 5 of the insulation housing 3 in an interlocking manner and electrically insulated from one another.

The same insulation housing 3 with the connection rails 4a, 4b, 4c should always be used for a delta and star connection by the respective interconnection devices 1, 2, wherein the change between delta and star connection is realized by the optional star point rail 9 as well as a separation of pin positions of the connection lugs 8a, 8b, 8c that are not required. For this reason, at least the insulation housings 3 of the two interconnection devices 1, 2 are designed as identical parts.

In addition to the three receiving portions 6a, 6b, 6c for receiving the respective connection rail 4a, 4b, 4c, the receiving structure 5 of the insulation housing 3 of the two interconnection devices 1, 2 also has a further receiving portion 6d, as indicated in FIGS. 1 and 3, which is used to hold the star point rail 9. To form the first interconnection device 1, the further receiving portion 6d is unused, whereas the star point rail 9 is mounted in the further receiving portion 6d to form the second interconnection device 2. The additional receiving portion 6d is arranged on an underside of the insulation housing 3 facing away from the receiving portions 6a, 6b, 6c, so that the star point rail 9 can be arranged below the connection rails 4a, 4b, 4c. For example, the further receiving portion 6d is open in an axial opposite direction with respect to a stator axis 100, so that the star point rail 9 can be inserted or mounted in the axial direction or from below in the further receiving portion 6d. The star point rail 9 can be fixed in the additional receiving portion 6d using hot caulking, for example.

The star point rail 9 has three groups of connection lugs 16a, 16b, 16c and a connection portion 17, partially concealed here by the insulation housing 3, which are connected to each other in one piece or made from a common material portion. The connection portion 17 is used to connect the connection lugs 16a, 16b, 16c or to form a star point of the star point circuit.

The connection lugs 16a, 16b, 16c of the star point rail 9 are arranged together with the connection lugs 8a, 8b, 8c of the connection rails 4a, 4b, 4c on a common pitch circle 101, only partially shown, distributed around the stator axis 100, wherein the connection lugs 8a, 8b, 8c of the connection rails 4a, 4b, 4c and the connection lugs 16a, 16b, 16c of the star point rail 9 are arranged in groups alternately one after the other in the circumferential direction. In other words, the connection lugs 8a, 8b, 8c of the connection rails 4a, 4b, 4c and the connection lugs 16a, 16b, 16c of the star point rail 9 are arranged alternately one behind the other in the circumferential direction. Here, the connection portion 17 is connected to connection lugs 16a, 16b, 16c in the center of the respective group and the rail portions 7a, 7b, 7c are connected to connection lugs 8a, 8b, 8c at least approximately in the center of the respective group in order to optimize the vibration properties of the connection lugs 16a, 16b, 16c and the connection lugs 8a, 8b, 8c in an installation situation. To ensure this in turn, the positions of the connection lugs 8a, 8b, 8c, 16a, 16b, 16c of the second interconnection device 2 must be different from the positions of the connection lugs 8a, 8b, 8c of the first interconnection device 1 or offset in the circumferential direction, which is realized by inserting the stator winding 12 into the stator body 11 with a slot offset.

FIG. 4 shows a second stator unit 20 for a second electrical machine, which also comprises a stator body 11 and a multi-phase stator winding 12. The stator body 11 and the stator winding 12 of the second stator unit 20 are of the same design or identical to the stator body 11 and the stator winding 12 of the first stator unit 10, wherein the stator winding 12 of the second stator unit 20 is inserted into the stator body 11 offset by two stator slots 13 relative to the stator winding 12 of the first stator unit 10. As a result, the installation position of the stator body 11 and the interconnection devices 1, 2 always remains the same, whereas the positions of the connection lugs 8a, 8b, 8c and the winding ends 14 or the connection regions 102 are different in order to enable the advantageous design of the bus bars.

The phase strands U, V, W are connected via the second interconnection device 2 to form a star connection, wherein the winding ends 14 of the first partial string 15a of the first phase strand U are connected to the connection lugs 8a of the first connection rail 4a, the winding ends 14 of the first partial strand 15a of the second phase strand V are connected to the connection lugs 8b of the second connection rail 4b and the winding ends 14 of the first partial strand 15a of the third phase strand W are connected to the connection lugs 8c of the third connection rail 4c. Furthermore, the winding ends 14 of the second partial strand 15a of the first phase strand U are in contact with the connection lugs 16a of the star point rail 9, the winding ends 14 of the second partial strand 15a of the second phase strand V are in contact with the connection lugs 16b of the star point rail 9 and the winding ends 14 of the second partial strand 15a of the third phase strand W are in contact with the connection lugs 16c of the star point rail 9.

For this purpose, the second interconnection device 2 or the insulation housing 3 is arranged in the same angular position as the first interconnection device 1 or the insulation housing 3 relative to the stator body 11, wherein the connection lugs 8a, 8b, 8c of the three connection rails 4a, 4b, 4c and the connection lugs 16a, 16b, 16c of the star point rail 9 of the second interconnection device 2 are arranged in a connection region 103 of n=18 stator slots 13 that is different from the connection region 102. For example, the two connection regions 102, 103 cover the same angular range, but are offset from each other in the circumferential direction.

In particular, each connection rail 4a, 4b, 4c has three connection lugs 8a, 8b, 8c and the star point rail 9 has nine connection lugs 16a, 16b, 16c, wherein the three connection lugs 16a, 16b, 16c of the star point rail 9 are arranged instead of the three connection lugs 8a, 8b, 8c of the first interconnection device 1. For this purpose, three of the connection lugs 8a, 8b, 8c are cut off in order to create a corresponding free area for the connection lugs 16a, 16b, 16c of the star point rail 9. Thus, the connection rails 4a, 4b, 4c of the first and second interconnection device 1, 2 have a common sub-portion, which is formed by the rail portions 7a, 7b, 7c and in portions by the connection lugs 8a, 8b, 8c. In simplified form, the same connection rails 4a, 4b, 4c can be used for the first and second interconnection devices 1, 2, wherein the connection rails 4a, 4b, 4c of the second interconnection device 2 are shortened to form the free areas for the connection lugs 16a, 16b, 16c of the star point rail 9.

In the exemplary embodiment shown, the connection lugs 8a are cut off at positions n3, n7 and n8, the connection lugs 8b at positions n9, n13 and n14 and the connection lugs 8c at positions n15, n19 and n20. Thus, as indicated in FIG. 3, the connection lugs 8a, 8b, 8c are assigned to the stator slots n4 to n6, n10 to n12 and n16 to n18, whereas the connection lugs 16a, 16b, 16c are assigned to the stator slots n1 to n3, n7 to n9 and n13 to n15. In other words, the connection region 103 of the second interconnection device 2 is arranged offset by two stator slots 13 relative to the connection region 103 of the first interconnection device 1 in order to provide the connection positions corresponding to the stator winding 12 with slot-based offset.

In the exemplary aspect shown, the winding ends 14 of the first phase strand U thus exit at the stator slots n1, n2, n4, n5, the winding ends 14 of the second phase strand V exit at the stator slots n7, n8, n10, n11 and the winding ends 14 of the third phase strand W exit at the stator slots n13, n14, n16, n17. In other words, the connection lugs 8a, 8b, 8c or 16a, 16b, 16c assigned to the stator slots n3, n6, n9, n12, n15 and n18 are unused.

A stator unit 10, 20 is thus proposed, which can be connected with a maximum number of identical parts to form a delta or star connection by inserting the stator winding 12 with a slot offset and adapting the interconnection device 1, 2 by adding or omitting the star point rail 9 and cutting off unneeded connection lugs 8a, 8b, 8c.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A set, comprising:
a first stator unit, having:
a first interconnection device configured to interconnect a stator winding to form a delta circuit, the first interconnection device having three connection rails configured to contact in each case one phase strand of the stator winding; and
an insulation housing with a receiving structure configured to receive the three connection rails; and
a second stator unit, having:
a second interconnection device configured to interconnect a stator winding to form a star point circuit, the second interconnection device having three connection rails configured to contact in each case one phase strand of the stator winding,
a star point rail configured to contact all phase strands of the stator winding; and
an insulation housing with a receiving structure configured to receive the three connection rails and the star point rail;
wherein the receiving structures of the first and second interconnection devices are of identical design, and/or wherein the insulation housings of the first and second interconnection devices are identical parts.

2. The set as claimed in claim 1,
wherein the receiving structure has three receiving portions for the three receiving rails on an upper side of the insulation housing and a further receiving portion for the star point rail on a lower side of the insulation housing, and
wherein the further receiving portion of the first interconnection device is unoccupied and the further receiving portion of the second interconnection device is occupied by the star point rail.

3. The set as claimed in claim 1, wherein the first and the second stator unit each comprise a stator body and a stator winding, the stator body and/or the stator winding of the first and the second stator unit being designed as identical parts.

4. The set as claimed in claim 1, wherein the three connection rails of the first and the second interconnection device each have a group of connection lugs configured to connect at least one winding end of a respective phase strand and a respective rail portion for connection to power electronics, the rail portions and at least some of the connection lugs of the first and second interconnection devices forming a common sub-portion.

5. The set as claimed in claim 4, wherein the first and second interconnection devices can be arranged and/or are arranged in an installation situation in a fixed angular position, the connection lugs of the three connection rails of the first interconnection device being arranged in a first connection region of n stator slots.

6. The set as claimed in claim 5, wherein the star point rail of the second interconnection device has a group of connection lugs configured to connect at least one winding end per phase strand and a connection portion configured to connect the connection lugs to form a star point, the connection lugs of the three connection rails of the second interconnection device and the connection lugs of the star point rail of the second interconnection device being arranged in a second connection region of n stator slots.

7. The set as claimed in claim 6, wherein the first and/or second connection region extends in an angular range of more than 90 degrees.

8. The set as claimed in claim 5, wherein an angular distance between the connection lugs corresponds to an angular distance between the stator slots.

9. The set as claimed in claim 4, wherein all connection lugs of the first and the second interconnection device are each located on a pitch circle, the connection lugs of the three connection rails of the first interconnection device being arranged in groups one after an other in a circumferential direction and the connection lugs of the three connection rails of the second interconnection device being arranged in groups alternately with respect to the connection lugs of the star point rail.

10. The set as claimed claim 4, wherein the rail portions of the three connection rails of the first interconnection device are each connected to connection lugs in a center of a respective associated group and/or the connection portion of the star point rail of the second interconnection device is in each case connected to connection lugs in the center of the respective associated groups.

11. The set as claimed in claim 6, wherein the connection lugs of the first interconnection device and the winding ends of the stator winding of the first stator unit are offset in a circumferential direction by at least one stator slot with respect to the connection lugs of the second interconnection device and the winding ends of the stator winding of the second stator unit and/or the first and second connection regions are offset in the circumferential direction by at least one stator slot.

12. A stator unit, comprising:
an interconnection device, the interconnection device having an insulation housing with a receiving structure, the receiving structure being formed for receiving three connection rails in order to form the interconnection device as a delta circuit, or for receiving three connection rails and a star point rail in order to form the interconnection device as a star circuit.

13. A method for manufacturing a stator unit comprising:
Providing a stator body, a stator winding and an interconnection device for interconnecting the stator winding to form a delta connection or a star connection;
when a delta circuit is to be produced, the stator winding is inserted into the stator body in a predefined first angular position and the interconnection device is arranged in a fixed angular position relative to the stator body, at least one winding end of a phase strand being contacted with a respective connection rail of the interconnection device in order to form a first stator unit; and
if a star connection is to be produced, the stator winding is inserted into the stator body in a predefined second angular position, the interconnection device is supplemented by a star point bar and the interconnection device is arranged in a defined angular position relative to the stator body,
wherein, to form a second stator unit, in each case at least one winding end of a phase strand is contacted with in each case one connection rail of the interconnection device and in each case at least one winding end of each phase strand is contacted with the star point rail.

14. The method as claimed in claim 13, wherein the connection rails are shortened to form free areas for the star point rail.

15. The method as claimed in claim 14, wherein the stator winding is inserted in the first angular position offset by at least one stator slot in a circumferential direction relative to the second angular position.

16. The set as claimed in claim 7, wherein the first and/or second connection region extends in an angular range of less than 180 degrees.

17. The set as claimed in claim 6, wherein the first and/or second connection region extends in an angular range of less than 180 degrees.
